(19) United States
(12) Patent Application Publication
(10) Pub. No.: US 2009/0113786 A1
(43) Pub. Date: May 7, 2009

(54) Process for Recovering Tall Oil or Tall Oil Fuel

(75) Inventors: Curt Lindstrom, Pitea (SE); Lars Stigsson, Saltsjobaden (SE); Nils Kjellberg, Jarfalla (SE); Per Sellerholm, Stockholm (SE)

Correspondence Address: BROWDY AND NEIMARK, P.L.L.C.;624 NINTH STREET, NW, SUITE 300, WASHINGTON, DC, 20001-5303, US

(73) Assignee: LINDE AKTIENGESELLSCHAFT, Wiesbaden (DE)

(21) Appl. No.: 11/663,344

(22) PCT Filed: Sep. 20, 2005
(86) PCT No.: PCT/EP05/54709

§ 371 Date: Dec. 1, 2008

(30) Foreign Application Priority Data
Sep. 21, 2004 (EP) 04022380.2

(51) Int. Cl. C10L 1/18; C11B 13/02

(52) U.S. Cl. 44/308; 530/209

(57) ABSTRACT

The invention relates to a process for providing tall oil or tall oil fuel from tall oil soap. In the process, tall oil soap, which may be neutralized with carbon dioxide, is treated with an alkaline earth metal compound to convert sodium soaps into alkaline earth metal soaps. The conversion reduces the sodium content and increases the heat value of the product. The converted product may be used to provide a low sodium fuel or it may be acidulated with a minimum of sulfur.

The present invention relates to a process for providing tall oil or tall oil fuel from tall oil soap. The invention also relates to the use of alkaline earth metal compounds for improving the recovery of tall oil and/or tall oil fuel. The invention provides improvements in the sodium and sulfur balance of a sulfate pulp mill.

Sodium and sulfur balances are of a very high importance when controlling the process and runnability of a Kraft or sulfate pulp mill. There are several methods in the prior art to control the S/Na-balance. Such methods include dumping of recovery boiler electrostatic precipitator dust, internal production of sulfuric acid, reduced sulfur content in input chemicals or fuels etc.

A major source for sulfur input is the use of sulfuric acid in the production of tall oil from tall oil soap. Tall oil soap is produced as a byproduct in the cooking of wood chips in the sulfate pulping process. The spent cooking liquor or “black liquor” contains sodium soaps of resin acids and fatty acids (tall oil) as well as some neutral or unsaponifiable components.

Crude tall oil soap is skimmed off the top of concentrated black liquor. The tall oil soap generally has a pH between 10 and 12, usually close to 12 and it still contains about 40 to 50% black liquor. The separated tall oil soap is traditionally acidulated with sulfuric acid to a pH of about 3 to 4 at which pH the sodium soaps of the tall oil fatty acids are released and can be separated from the aqueous phase. The free tall oil can be used to provide a number of different chemicals for various industrial applications.

The sulfuric acid, which is used in the acidulation increases the sulfur input and distorts the sulfur balance in the pulp mill. One method which has been used in the prior art to reduce the sulfur input in the tall oil soap acidulation is to replace part of the sulfuric acid with carbon dioxide. There are a number of patents relating to such processes.

Thus, for instance U.S. Pat. No. 3,901,869 (Westvaco) describes the acidulation of tall oil soap with carbon dioxide and water to a pH of 7 to 8. The resulting oil phase is separated from the aqueous bicarbonate brine phase and is then further acidulated with sulfuric acid.

U.S. Pat. No. 4,075,188 (Westvaco) describes an improvement of the carbon dioxide treatment by the use of a water-immiscible solvent such as hexane and naphtha in which the free fatty acids are more soluble than the soaps.

U.S. Pat. No. 4,495,095 (Union Camp) discloses acidulation of tall oil soaps with carbon dioxide under a pressure at which the carbon dioxide is in a supercritical state.

U.S. Pat. No. 5,286,845 (Union Camp) discloses neutralization of tall oil soap with carbon dioxide under pressure and separation of the bicarbonate brine also under pressure. Substantial savings in the use of sulfuric acid for the final acidulation are provided.

WO 95/23837 (Metsäbotnia) discloses a carbon dioxide neutralization of tall oil soap wherein an extra neutralization with sulfuric acid is performed before the separation of the bicarbonate brine and the neutralized soap. The final acidulation to free the tall oil is performed with sulfuric acid.

WO 98/29524 (AGA) discloses cleaning of the crude tall oil soap with carbon dioxide to remove lignin impurities prior to neutralization with carbon dioxide and/or sulfuric acid.

WO 2004/074415 (Linde) discloses treatment of tall oil soap in two steps with carbon dioxide to obtain a tall oil intermediate, which is then acidulated with a strong acid. The process avoids recirculation of sulfur compounds to the chemical recovery of the mill by disposing externally of the salty brine.

Despite the attempts to reduce the sulfur input in the tall oil recovery, most mills are forced to use sulfuric acid at least for the final acidulation. The industrially useful methods available only replace around 35% of the sulfuric acid used in the acidulation step.

An alternative to recovering tall oil from the soaps is to use the tall oil soaps or the crude tall oil as fuel in the furnaces of the mill. This reduces the input of sulfur since it is not necessary to fully free the tall oil and thus less sulfuric acid is needed.

In an attempt to improve the use of the tall oil soap as fuel, SE patent 503 856 (AGA) discloses a process for reacting tall oil soap with carbon dioxide to free a part of the sodium of the soaps into the aqueous phase and to mix the oil phase of the reaction mixture with a combustible solvent such as diesel oil to provide a fuel without having to add sulfur into the process.

However, combustion of the tall oil soaps poses another problem in that it affects the sodium balance of the mill's chemical recovery. Moreover, the high level of sodium in the tall oil soap makes it unsuitable as a fuel for the lime sludge reburning kiln of the mill. The sodium in tall oil soap also cause problems when burned in other furnaces e.g. plugging.

In a process for recovering volatile tall oil components, US Patent application 20030120095 discloses a process for the recovery of unsaponifiable components of tall oil soap, crude tall oil or tall oil pitch. The saponifiable compounds are first transformed into metal soaps in order to reduce the viscosity and to facilitate distillation. The treated mixture is then subjected to distillation to recover volatile unsaponified components such as sterols and vitamins. The remaining saponified mixture may then be acidulated in the traditional way with a mineral acid.

There exists a need to reduce the amount of sulfuric acid in the treatment of tall oil soap. Specifically, there is a need to reduce the input of sulfur into the tall oil recovery cycle so as to reduce the sulfidity, i.e. the amount of sulfur in the over-all sulfate process of a sulfate pulp mill. There is also a need for improving the control of the sodium/sulfur balance of a sulfate pulp mill and to improve the recovery of chemicals and useful products from the aqueous phases of the tall oil recovery cycle.

The present invention sets out to solve these and other problems of the prior art and to provide a process for recovery of valuable tall oil products with a reduced amount of sulfur input. The invention also enables the recovery valuable tall oil products with an improved sodium balance in the chemical control of the mill.

In accordance with a preferred embodiment of the invention, there is provided a process for providing tall oil or tall oil fuel from the byproducts of a sulfate pulping process. The process comprises the steps of
providing an aqueous tall oil soap at a pH between 10 and 12, wherein fatty acids and resin acids contained therein are in the form of sodium soaps;
converting at least a significant portion of said sodium soaps into alkaline earth metal soaps in order to reduce the sodium content thereof and to provide a converted product;
optionally neutralizing said tall oil soap to a pH of 7 to 9 with carbon dioxide before or after said conversion to provide a neutralized product;
separating the converted and optionally carbon dioxide neutralized product into an aqueous phase and an oil phase;
recovering the oil phase of said converted and optionally carbon dioxide neutralized product and providing a low sodium fuel based thereon; or
acidulating the oil phase of said converted and carbon dioxide neutralized product with an acid to provide tall oil.

The conversion of the sodium soaps into alkaline earth metal soaps is preferably performed with an alkaline earth metal compound selected from salts and oxides of calcium and magnesium and mixtures thereof. The conversion reaction is preferably performed to completion, i.e. until an equilibrium is reached between the converted (alkaline earth metal) soaps and the sodium soaps.

In a preferred embodiment of the invention tall oil soap is first contacted with an alkaline earth metal compound and thereafter the reaction mixture is neutralized with carbon dioxide. Finally, the oil phase is separated from the aqueous brine phase.

In another preferred embodiment of the process, the tall oil soap is first neutralized with carbon dioxide and water. The sodium soaps remaining in the resulting mixture or in the separated soap oil are then converted into alkaline earth metal soaps. Preferably a substantial part and most preferably more than 50% of the sodium soaps in the soap oil are thus converted.

Converting the sodium soaps into alkaline earth metal soaps reduces the sodium content of the oil phase of the tall oil soap or soap oil. Moreover, the resulting oil phase generally has a higher dry content and a less sticky consistency and is thus easier to handle than the traditional sodium soap products.

After recovery, the low sodium oil phase is suitable for providing a biological fuel in place of fossil fuels. Its preferred use is in the lime kiln and other oil fired installations at a sulfate pulp mill. The recovered oil phase may be used as a fuel as such. In a preferred embodiment of the invention, the biological fuel additionally contains an organic solvent, which further improves the combustion properties of the fuel. The calorimetric value of the fuel, which is based on the converted soap oil, is improved over that of a fuel based on a non-converted soap oil. Furthermore, the NOX emission from the novel biological fuel has been found to be low.

In a preferred embodiment of the invention, the oil phase of the carbon dioxide neutralized and converted soap oil is acidulated with an acid which lacks sulfur. The acidulation provides a tall oil phase and an aqueous phase with a pH which is preferably about 3 to 4. Tall oil is recovered from said tall oil phase. In this way tall oil may be produced without any sulfur input at all.

In the following the invention will be described in greater detail and illustrated with specific experiments.

In the description and claims of the present specification the term “crude tall oil soap” and “tall oil soap” refers to the tall oil soap skimmed off black liquor in the traditional manner. The tall oil soap has a pH above 10 and generally about pH 11 to 12. It contains about 40 to 50% aqueous black liquor and the rest fatty acids and resin acids in the form of soaps as well as unsaponifiable components generally found in such products. In the unconverted “tall oil soap”, the soaps are all in sodium form.

The term “converted tall oil soap” refers specifically to a tall oil soap which has the same composition as traditional tall oil soap but wherein at least a significant part of the saponifiable components have been converted from sodium soaps into alkaline earth metal soaps.

The term “soap oil” refers to a product, which has been obtained by the neutralization of tall oil soap with carbon dioxide and water to free a part of the tall oil soaps and by subsequent separation of the aqueous brine phase to provide an oil phase. The soap oil has a pH below 9 and typically between 7 and 8. The term “converted soap oil” refers specifically to a soap oil, wherein at least a substantial portion of the fatty acid and resin acid soaps are in the form of alkaline earth metal soaps.

The term “neutralization” or “carbon dioxide neutralization” refers in the present specification and claims, unless otherwise specified, to a treatment of tall oil soap with carbon dioxide to lower its pH to a value below 9 and typically between 7 and 8.

The raw material of the present invention is crude tall oil soap or tall oil soap, which has been purified by washing with water or the like solvent or by cleaning with carbon dioxide. Especially, when the oil phase is to be used as a fuel, there is no need to purify the crude soap in any way.

The aim of the process is to provide a valuable product from the tall oil soap without increasing the sulfur load of the sulfate pulp mill and without negatively affecting the sodium balance.

An aim of the invention is also to provide the aqueous phases of the tall oil soap treatment cycles in a form which either allows for recovery of the chemicals contained in said aqueous phases in the pulping or chemical recovery system of the mill or enables external cleaning or utilization of the aqueous phase.

The aim of the invention can be realized either by producing a tall oil fuel with a low sodium content or by producing tall oil by a low sulfur process or totally without sulfur.

In the preferred aspect of the present invention tall oil soap wherein the fatty acids and resin acids are in the sodium soap form are neutralized with carbon dioxide and water to a pH below 8 or until the emulsion formed breaks into an oil phase (soap oil) and an aqueous bicarbonate brine phase. The reaction which frees part of the saponified fatty acids and/or resin acids can be described as follows.

RCOONa+CO₂+H₂O->RCOOH+NaHCO₃

This reaction is known in the prior art and it can be performed in any of the manners described in the prior art. A preferred reaction according to the present invention takes place with carbon dioxide at atmospheric pressure, although pressurized systems may also be used. As water is a reagent in the reaction, water has to be added to the tall oil soap even though the soap contains a large amount of water in itself. The ratio by weight of aqueous soap to added water is suitably between 2:1 and 1:2, preferably 1.2:1 to 1:1.2. In a typical operation, the amount of water just about equals that of the tall oil soap.

The amount of carbon dioxide that needs to be added to the mixture depends on the properties of the raw material. However, carbon dioxide should be added until a sufficient amount of fatty and resin acids have been freed so as to make the oil-in-water emulsion break. This takes place at a pH below 9 and typically at a pH between 7 and 8.

When the emulsion breaks, the reaction mixture is allowed to settle in an oil phase floating on top of an aqueous bicarbonate brine phase. The phases are separated and the bicarbonate brine is preferably circulated to chemical recovery. The oil phase comprises soap oil, wherein part of the tall oil fatty and resin acids is in free acid form and the other part is in the form of sodium soaps.

According to the invention, the sodium soaps of the tall oil soap or soap oil are converted into alkaline earth metal soaps by reaction with an alkaline earth metal compound. The conversion reaction is believed not to affect the free fatty acids and resin acids nor the unsaponifiable components of the soap oil. The conversion may be performed before or after the carbon dioxide neutralization. The aqueous phase of the mixture may be separated after the neutralization and/or after the conversion.

The alkaline earth metal of the compound used in the conversion of the present invention may be any alkaline earth metal such as calcium, magnesium, strontium or barium. However, calcium and magnesium compounds are preferred. The most preferred converting compounds are calcium compounds.

The preferred alkaline earth metal compounds used in the conversion are selected from salts and oxides of calcium and magnesium. It is also possible to use and mixtures thereof. Preferred converting compounds are selected from calcium oxide, calcium hydroxide, calcium carbonate, calcium nitrate, calcium chloride, calcium sulfate, magnesium hydroxide, magnesium nitrate, magnesium chloride, magnesium sulfate and mixtures thereof.

The selection of the alkaline earth metal compound depends on the desired advantages in the process and in the end product. Calcium oxide and calcium carbonate are preferred because they form a part of the compounds already present in a sulfate pulp mill. Calcium added in the conversion process will end up in the oil phase and when this is burned in a lime kiln the calcium will provide a continuous make-up of calcium. This will also stabilize the lime kiln process. Calcium nitrate and magnesium nitrate are preferred because they are bulk chemicals on the market, they are easily soluble in water and because the nitrate in the aqueous phase of the conversion reaction can be recovered and utilized externally e.g. for fertilization purposes or as a nutrient e.g. in waste water treatment. Calcium and magnesium sulfates also dissolve well in water but the use of such sulfates adds to the sulfur input in the mill, which is to be avoided unless the aqueous phase can be cleaned externally from the mill. Calcium chloride, although soluble in water has been found to provide a rather sticky oil phase, wherefore its use is not among the preferred ones.

The amount of converting alkaline earth metal compound is preferably sufficient to convert as much as possible and preferably more than 50% of the sodium soaps into alkaline earth metal soaps. Some sodium soaps will, however, generally remain in the mixture because of the chemical equilibrium reactions.

The conversion reaction is preferably performed by adding the alkaline earth metal compound to the soap oil and heating the mixture at about 40 to 90° C., preferably about 50 to 75° C. until a substantially complete conversion has taken place. The alkaline earth metal compound is preferably at least partially soluble in the aqueous phase of the reaction mixture and it may be added as a water solution. The reaction mixture is preferably stirred during the reaction so as to improve the contact between the reagents.

The reaction time of the conversion is not critical and can be experimentally determined by simple analysis of the amount of sodium left in the oil phase. In the preferred reaction, substantially all of the sodium soaps remaining in the soap oil are converted into alkaline earth metal soaps and the sodium is transferred into the aqueous phase.

Water is preferably removed from the mixture after the conversion step. It has been found that converting the sodium soaps in the soap oil into alkaline earth metal soaps improves the separation of the oil phase and the aqueous phase and because of this, the converted soap oil can be obtained with a high dry content. The water content of the converted soap oil is typically 40-50%, and it may easily be lowered to below 30%.

After a successful conversion according to the present invention, the level of sodium left in the converted soap oil is very low compared to the initial sodium content, which is typically about 60 to 65 g/kg calculated on the dry weight of the soap (water-free soap). With the present invention the sodium content is easily lowered to 20 g/kg or less. This is an acceptable value for most fuel purposes. However, by the present invention it is possible to provide a fuel with an even lower sodium content based on the converted soap oil. Thus the sodium content of the soap oil may be reduced to less than 10 g/kg or even below 5 g/kg. When an organic solvent is used in the soap oil, as described in greater detail below, the sodium content falls below 1 g/kg, which is very low indeed. The reduction in sodium content may be optimized by the reaction conditions such as the amount and kind of alkaline earth metal compound, reaction time, temperature, stirring, etc. Such optimization is within the general skills of the person skilled in the art.

The converted soap oil may be produced totally without any input of sulfur. It provides a fuel with a low sodium content and a high dry content, as mentioned above, and the fuel also has a good heat value. According to a preferred aspect of the invention the converted soap oil is used as a fuel with low sodium content. The conversion preferably also increases the calorimetric value of the fuel to 25 MJ/kg or more, preferably 30 MJ/kg or more calculated on the total weight of the soap oil. The converted soap oil is easy to handle and it provides a biological fuel, which can easily replace other fuels in the mill. Because of its low sodium content, the converted soap oil is suitable as a fuel for lime kilns as well as other furnaces of the mill. It is also suitable for the production of energy and it has the advantage that its combustion does not produce carbon dioxide emissions from fossil fuels.

It has also been found that the soap oil may be mixed with an organic solvent either before or after the conversion reaction. In case the soap oil is to be used as fuel, the organic solvent is preferably a combustible organic solvent. The solvent is preferably also one, which is capable of dissolving tall oil calcium and/or magnesium soaps. Suitable organic solvents are for example diesel oil, turpentine, hexane, heptane, etc. For fuel purposes diesel oil has proven an excellent solvent since it adds to the fuel value of the converted soap oil. Moreover, diesel oil has proven better in dissolving the calcium and magnesium soaps of the converted soap oil than turpentine. Adding an organic solvent to soap oil should be performed after the soap oil has been separated from the aqueous bicarbonate brine.

Using an organic solvent also improves the handling properties of the converted soap oil and reduces the sodium content further. Adding water to the converted soap oil together with the organic solvent helps to reduce the sodium content of the oil phase. It is generally preferred to remove water before combustion if it can easily be separated.

If the biological fuel provided by the converted soap oil is to be stored at ambient temperatures for any longer periods, it should preferably be treated with heat or antimicrobial agents to prevent mold growth. A heat treatment above 50° C., preferably above 60° C. will improve the shelf life of the fuel. Sterilization at temperatures above 70° C. and especially at 80 to 90° C. has proven very effective. The heat treatment may also facilitate removal of surplus water before the combustion.

In an alternative aspect of the invention the sodium soaps of tall oil soap are converted into alkaline earth metal soaps without any neutralization of the soap with carbon dioxide.

In this reaction, the tall oil soap is preferably mixed with water and then reacted at a temperature between 40 and 90° C., preferably 50 to 80° C. with an alkaline earth metal compound preferably selected, as above, from oxides and salts of calcium and magnesium. Since the tall oil soap contains more sodium soaps than does the soap oil described above, a larger amount of alkaline earth metal compound should be added to the soap in order to convert all or substantially all of the sodium soaps into alkaline earth metal soaps. The mixture should also be stirred to assist in keeping the reaction mixture uniform.

After the reaction is complete, the aqueous phase and the soap phase are separated to remove the sodium. The converted soap maybe washed e.g. with water to reduce the amount of sodium remaining in the converted product.

The aqueous phase contains a fair amount of sodium hydroxide and it may be used in the sulfate pulping process as a source of sodium hydroxide or it may be returned to the chemical recovery system or be combined with black liquor.

The converted tall oil soap may be used as a fuel with a low sodium content. It is not as easy to handle as the soap oil described above, but it has a good heat value and it may also be used to replace fossil fuels with the same advantages as described above.

The converted tall oil soap may also be neutralized with carbon dioxide and water in the same manner as that described for non-converted tall oil soap. The neutralization with carbon dioxide proceeds smoothly and the resulting oil phase does not materially differ from that produced by first neutralizing and then converting the soap oil. The converted soap oil may be used for providing a fuel in the same way as described above.

Because of the inherent relatively high content of water in the novel biological fuel, it is recommended to start the combustion by first heating the apparatus with another fuel.

As an alternative to providing fuel and irrespective of in which order the neutralization and conversion of the soap has been performed, the resulting converted soap oil may be further acidulated to provide free tall oil. The acidulation may be preformed with sulfuric acid or with a non-sulfur acid.

In case sulfuric acid is used to free the tall oil from the converted soap oil, this cause input of sulfur into the mill. However, it has been found that when the soaps of the tall oil have been converted into alkaline earth metal soaps, the acidulation requires less sulfuric acid than if the no conversion has been made. Thus, if acidulation of tall oil soap with only sulfuric acid is taken to represent 100%, the use of the prior art carbon dioxide neutralization will reduce the amount of sulfuric acid needed with about 35%. However, when a conversion in accordance with the present invention is performed, an acidulation after carbon dioxide neutralization step will require only about 50% of the sulfuric acid initially needed. The reason for this reduction in sulfuric acid consumption is not fully understood, but it may be at least partially caused by the improved separation of the aqueous phase and the oil phase in the converted product.

If a totally sulfur-free acidulation is desired, the carbon dioxide neutralized and converted soap oil may be acidulated with a non-sulfur acid to provide a tall oil phase and an aqueous phase containing alkaline earth metal compounds and having a pH below 5 and preferably between 3 and 4. The tall oil recovered from such an acidulation is of the same quality as tall oil produced with sulfuric acid.

Suitable non-sulfur acids are typically selected from hydrochloric acid, formic acid, per-acetic acid, boric acid and nitric acid. Nitric acid and formic acid are preferred.

The aqueous phase of the acidulation, irrespective of whether it is made with sulfuric acid or a non-sulfur acid can be sent to chemical recovery or pulping and the sulfur-free liquid may also be sent to external cleaning.

The invention will be further illustrated by the following examples.

### REFERENCE EXAMPLE

### Neutralization of Tall Oil Soap With Carbon Dioxide

The equipment used in the trial included a pilot plant reactor normally used for pulp experiments. Tall oil soap from a sulfate pulp mill (800 g) and water (1030 ml) were added to the reactor. Mixing started and then carbon dioxide was added. A constant pressure (about 150 kPa) in the reactor was achieved by adding carbon dioxide. After about 20 minutes reaction the mixing was stopped and the mixture was allowed to settle for about 30 minutes. After this the separated brine was taken out from the reactor by using an evacuation valve. Subsequently, the produced soap oil was taken out by using the same valve. The pH of the product was between 7 and 8. It had a sodium content of 40.2 g/kg calculated on the dry weight.

The same principles were used to provide soap oil in the examples below.

### Example 1

### Tall Oil Soap Conversion From Sodium To Alkaline Earth Metal Soap

Tall oil soap from a sulfate pulp mill was used in the experiments. The soap had a sodium content of about 65 g/kg calculated on the dry weight of the soap. The soap was added to the reactor used in the Reference Example and mixed with water and different calcium compounds. The reaction mixture was heated to about 50° C. for a time specified in Table 1. The mixture was stirred at 100 rpm during the reaction.

TABLE 1a
Tall oil soap conversion with alkaline earth metal

| Tall | | Alkaline | Reaction | | |
|---|---|---|---|---|---|
| oil soap | Water | earth/water | time | Stirring | Test # |
| 802 g | 920 ml | Ca(NO₃)₂ 29 g/716 ml | 40 min | 100 rpm | 417-9c |
| 803 g | 500 ml | CaCO₃ 72 g/200 ml | 21 min | 100 rpm | 417-9b |

After the reaction the oil phase (soap phase) and the aqueous phase were separated and the sodium and alkaline earth contents in the phases as well as the dry content of the oil phase were measured. The results of the tests are shown below in Table 1b.

TABLE 1b
Tall oil soap conversion result

| Na/aq. | | Na/oil | | | |
|---|---|---|---|---|---|
| g/l | Ca/aq g/l | g/kg | Ca oil g/kg | Dry matter % | Test # |
| 24.1 | 6.7 | 36.2 | 3.96 | 64.5 | 417-9c |
| 22.0 | 1.19 | 59.7 | 1.65 | 50.8 | 417-9b |

### Example 2

### Tall Oil Soap Neutralization And Conversion

Tall oil soap from a sulfate mill was converted to alkaline earth metal soaps in connection with the neutralization of the soap with carbon dioxide to form a converted soap oil. The equipment used was the same as in the Reference Example and the carbon dioxide neutralization was performed as described in said Reference Example.

Various alkaline earth metal compounds were added to the soap at various points of the experiment. The temperature of the tests was generally about 50° C. but in test #423-3a the temperature was 73° C. and in test #423-3c the temperature was 40° C. In these two tests the alkaline earth metal compound was added at the end of the neutralization while in the other tests the alkaline earth metal compound was added at the start of the carbon dioxide neutralization. In test #423-3b the soap was first allowed to react with the alkaline earth metal and then carbon dioxide was added to the so converted mixture. The reaction parameters are shown in Table 2a.

TABLE 2a
Tall oil neutralization with CO₂ and
conversion with alkaline earth metal

| Tall | | | Alkaline | Reaction | | | |
|---|---|---|---|---|---|---|---|
| oil soap | Water | | earth/water | time | Stirring | | Test # |
| 806 g | 1050 | ml | Ca(NO₃)₂ 16 | 95 min | 250 | rpm | 423-3a |
| | | | g/716 ml | | | | |
| 824 g | 0 | ml | Ca(NO₃)₂ 23 | 90 min | 250/110 | rpm | 423-3b |
| | | | g/716 ml | | | | |
| 803 g | 1050 | ml | Ca(NO₃)₂ 16 | 95 min | 250 | rpm | 423-3c |
| | | | g/716 ml | | | | |
| 390 g | 500 | ml | MgSO₄ 82 g | 10 min | 250 | rpm | 410-8 |

After the reaction the oil phase (soap oil phase) and the aqueous phase were separated and the sodium and alkaline earth contents in the phases as well as the dry content of the oil phase were measured. The results of the tests are shown below in Table 2b. The X-marked columns indicate that the values were not measured.

TABLE 2b
Tall oil soap neutralization and conversion result

| Na/aq. | Ca/aq | Na/oil | Ca/oil | Mg/oil | | |
|---|---|---|---|---|---|---|
| g/l | mg/l | g/kg | mg/kg | | Dry matter % | Test # |
| 16.2 | 20.6 | 15.2 | 23800 | | 81.2 | 423-3a |
| 24.9 | 140 | 8.93 | 39800 | | 82.5 | 423-3b |
| 14.9 | 163 | 21.4 | 18300 | | 65.9 | 423-3c |
| X | X | 28.0 | 2510 | 24200 | 61.9 | 410-8 |

The results show that it is possible to provide a low sodium content in a carbon dioxide neutralized soap oil by converting the sodium soaps to alkaline earth metal soaps.

As a reference, the soap used in test #423-3b was neutralized in the same manner as in test #423-3b but without any conversion. The non-converted and converted soap oils were analyzed and it was found that while the non-converted soap oil had a Na content of 2.4% by weight (calculated on the total weight) and a Ca content of 0.2% by weight, the converted soap oil had a Na content of only 0.37% by weight and a Ca content of 2.2% by weight.

The two soap oils were also analysed according to the test method ASTM D 4809 for calorimetric value and it was found that the calorimetric value had risen by the conversion from 23.18 MJ/kg for the non-converted soap oil to 31.16 MJ/kg for the converted soap oil.

This indicates that the conversion improves the fuel properties of the soap oil to a significant degree.

### Example 3

### Soap Oil Conversion

Soap oil was produced as in the Reference Example and was treated with various calcium compounds to convert their sodium soaps to calcium soaps. Water was also added to the soap oil to facilitate the reaction. The reaction mixture was heated to a temperature between 40 and 90° C. The mixture was stirred during the reaction.

The reagents and reaction conditions are shown in Table 3a:

TABLE 3a
Soap oil conversion

| | | Alkaline | Reaction | | | |
|---|---|---|---|---|---|---|
| Soap oil | Water | earth/water | time | Stirring | | Test # |
| 200 ml | 390 ml | CaCl₂ | 35 min | 100 | rpm | 410-4d |
| | | 100 g/500 ml | | | | |
| 520 ml | 500 ml | Ca(NO₃)₂ | 95 min | 120-80 | rpm | 417-2 |
| | | 15.7 g | | | | |
| 646 ml | 716 ml | Ca(NO₃)₂ | 20 min | 10 | rpm | 423-2 |
| | | 16.3 g | | | | |

After the reaction the oil phase (soap oil phase) and the aqueous phase were separated and the sodium and alkaline earth contents in the phases as well as the dry content of the oil phase were measured. The results indicate that test 423-2, wherein calcium was added in a separate step after the separation of the aqueous brine phase did not provide as good results as adding the calcium and the carbon dioxide to the same mixture. The results of the tests are shown below in Table 3b.

TABLE 3b
Tall oil soap conversion result

| Na/aq. | | Na/oil | | | |
|---|---|---|---|---|---|
| g/l | Ca/aq g/l | g/kg | Ca oil g/kg | Dry matter % | Test # |
| 13.1 | 21.3 | 12.4 | 62.9 | 51.4 | 410-4d |
| 17.1 | 3.1 | 19.1 | 28.2 | 72.6 | 417-2 |
| 10.5 | 5.9 | 21.3 | 26.1 | 69.9 | 423-2 |

The results show that it is possible to provide a low content of sodium in a separated soap oil by converting its sodium soaps into alkaline earth metal soaps.

### Example 4

### Converted Soap Oil As Fuel

A converted soap oil was produced substantially as in Example 3. Thus, a tall oil soap was treated with water and carbon dioxide to produce an aqueous phase and an oil phase. The phases were separated and the oil phase was converted with an aqueous solution of calcium nitrate. Surplus water was removed and the resulting biological fuel had a water content of 28% and an ash content of 12%.

The fuel was tested in a combustion furnace with an atomizing burner. The fuel was heated to 70-90° C. to reduce its viscosity before feeding into the burner.

The fuel performed satisfactorily and had a stable flame. The calorimetric value of the fuel was 25-30 MJ/kg.

### Example 5

### Mixing With Organic Solvents

The neutralization of tall oil soap with carbon dioxide and the use of alkaline earth metal salts to convert the sodium soaps to alkaline earth metal soaps was tested in combination with an organic solvent such as turpentine and/or diesel oil. The tests showed that adding water and turpentine and/or diesel oil to the soap oil is very effective in reducing the sodium content of the converted soap oil. In a preferred test a sodium level below 1 g/kg was obtained.

In all of the tests the neutralization was performed with carbon dioxide substantially as indicated in the Reference Example. The diesel oil was added to the soap oil after separation of the bicarbonate brine. The calcium compound was added either to the soap or to the soap oil.

The parameters and results for a set of test runs with diesel oil and addition of calcium salts at various points of the experiment are shown below in Table 4.

TABLE 4

| | Ca | | | | | |
|---|---|---|---|---|---|---|
| Ca | addition | Soap oil/ | | Ca in | Na in | |
| compound | point | Diesel oil | | oil phase | oil phase | Test # |
| CaCl₂ 100 g | Soap oil | 600/400 | ml | 32.7 g/kg | 0.31 g/kg | 410-3b |
| CaCl₂ 100 g | Soap | 540/400 | ml | 40.2 g/kg | 3.59 g/kg | 410-3c |
| CaO 21 g | Soap oil | X/400 | ml | 59.1 g/kg | 8.26 g/kg | 410-7b |

### Example 6

### Acidulation of Soap Oil

The converted soap oil obtained in test #417-2 of Example 5 was acidulated with 2 M sulphuric acid in the traditional manner. The resulting free tall oil at a dry content of 97.9% contained 12 mg/kg of sodium. Its fatty acids and resin acids were similar to those obtained by a conventional acidulation with only sulphuric acid.

The amount of sulphuric acid required for the acidulation was only 260 ml, which is 30% less than the amount of sulphuric acid needed to acidulate a traditional carbon dioxide neutralized and non-converted soap oil. It is about half of the amount needed to acidulate the tall oil soap with only sulphuric acid.

Trials were also made to acidulate the soap oil with non-sulfur acids. It was found that especially formic acid performed very well and provided a good free tall oil.

The above examples serve to illustrate the invention. Based on the above description and examples a person skilled in the art will be able to utilize the invention in many ways and to vary the compounds, their addition points and amounts so as to obtain a product suitable for his specific needs. Such variations and modifications are considered to be within the scope of the appended claims.

Any references to prior art publications are considered to include those prior art publications into the present specification by said reference.

1. A process for providing tall oil or tall oil fuel, characterized in
a) providing an aqueous tall oil soap at a pH between 10 and 12. wherein fatty acids and resin acids contained therein are in the form of sodium soaps b) converting at least a significant portion of said sodium soaps into alkaline earth metal soaps in order to reduce the sodium content thereof and to provide a converted product, c) optionally neutralizing said tall oil soap to a pH of 7 to 9 with carbon dioxide before or after said conversion to provide a neutralized product, d) separating the converted and optionally carbon dioxide neutralized product into an aqueous phase and an oil phase, e) recovering the oil phase of said converted and optionally carbon dioxide neutralized product and providing a low sodium fuel based thereon, or f) acidulating the oil phase of said converted and carbon dioxide neutralized product with an acid to provide tall oil.

2. A process according to claim 1, wherein aqueous tall oil soap is reacted with an alkaline earth metal compound and the reaction mixture is neutralized with carbon dioxide, to provide a neutralized and converted product having an aqueous bicarbonate brine phase and an oil phase, whereafter the bicarbonate brine is separated and the neutralized and converted oil phase is recovered as converted soap oil.

3. A process according to claim 1, wherein aqueous tall oil soap is neutralized with carbon dioxide and the neutralized product is reacted with an alkaline earth metal compound, and resulting aqueous bicarbonate brine resulting from said neutralization is separated from the neutralized product before or after said reaction with said alkaline earth metal compound.

4. A process according to claim 3, wherein said neutralization is performed in the presence of said alkaline earth metal compound.

5. A process according to claim 1, wherein said tall oil soap is reacted with an alkaline earth metal compound and the converted soap is recovered as a biological fuel.

6. A process according to claim 1, wherein said conversion reaction is performed with an alkaline earth metal compound selected from salts and oxides of calcium and magnesium and mixtures thereof.

7. A process according to claim 6, wherein said compound is selected from calcium oxide, calcium hydroxide, calcium carbonate, calcium nitrate, calcium chloride, calcium sulfate, magnesium hydroxide, magnesium nitrate, magnesium chloride, magnesium sulfate and mixtures thereof.

8. A process according to claim 6, wherein said alkaline earth metal compound is soluble in water and is added dissolved in water.

9. A process according to claim 1, said conversion reaction is performed at a temperature of 40 to 90° C.

10. A process according to claim 9, wherein a sufficient amount of alkaline earth metal compound is used in said conversion reaction to convert more than 50% of said sodium soaps into alkaline earth metal soaps.

11. A process according to claim 1, wherein the oil phase of said neutralized product is mixed with a combustible organic solvent.

12. A process according to claim 4, wherein said organic solvent is selected from diesel oil, turpentine, hexane and heptane.

13. A process according to claim 1, wherein said low sodium fuel contains sodium less than 20 g/kg.

14. A process according to claim 11, wherein said neutralized product comprises converted soap oil having a sodium content of less than 1 g/kg calculated on the dry weight of the soap oil.

15. A process according to claim 2, wherein said alkaline earth metal compound comprises calcium nitrate and said soap oil is recovered as a biological fuel having a calorimetric value of at least 25 MJ/kg.

16. A process according to claim 1, wherein said alkaline earth metal comprises calcium and said fuel is burned in a lime kiln for providing heat and make-up calcium.

17. A process according to claim 1, wherein said aqueous phase of said converted and non-neutralized product is recovered as a source of sodium hydroxide for use in the Kraft pulping of wood.

18. A process according to claim 1, wherein said neutralization is performed by adding water to said aqueous tall oil soap in all amount to provide a weight ratio of aqueous soap to added water between 2:1 and 1:2.

19. A process according to claim 1, wherein the oil phase of said converted and neutralized product is acidulated with a non-sulfur acid to provide a tall oil phase and an aqueous phase with a pH below 5.

20. A process according to claim 19, wherein said acidulating acid is selected from hydrochloric acid, formic acid, per-acetic acid, boric acid and nitric acid.

21. A process according to claim 1, wherein the aqueous phase having a pH below 5 is recovered and fed to a treatment selected from external cleaning, chemical recovery and pulping.

22. A process according to claim 1, wherein said conversion is performed with an alkaline earth metal compound selected from calcium nitrate and magnesium nitrate and the aqueous phase of said neutralized product is recovered and used for fertilization purposes or as a nutrient in waste water treatment.

23. A process according to claim 1, wherein said fuel is treated with heat or with an anti-microbial agent to increase its shelf life.

24. A process according to claim 1, wherein said conversion is performed for lowering the sodium content and/or increasing the calorimetric value of fuel obtained from tall oil soap.

25. A process according to claim 1, wherein said process is performed for reducing the input of sulfur in the recovery of valuable tall oil products.

26. (canceled)

27. (canceled)
